(19) United States
(12) Patent Application Publication
(10) Pub. No.: US 2010/0127671 A1
(43) Pub. Date: May 27, 2010

(54) INTERLEAVED POWER FACTOR CORRECTOR BOOST CONVERTER

(75) Inventor: Kjell Lidström, Burea (SE)

Correspondence Address: NIXON & VANDERHYE, PC, 901 NORTH GLEBE ROAD, 11TH FLOOR, ARLINGTON, VA, 22203, US

(73) Assignee: DIPOLAR AB, Skelleftea (SE)

(21) Appl. No.: 12/448,675

(22) PCT Filed: Jan. 8, 2007
(86) PCT No.: PCT/SE2007/050003

§ 371 Date: Jan. 25, 2010

(51) Int. Cl. G05F 1/70

(52) U.S. Cl. 323/207

(57) ABSTRACT

The present invention relates to an interleaved power factor (PFC) correction boost converter. In order to enable the interleaved PFC boost converter circuit to operate over a wide range of input voltages and frequencies the circuit comprises: A first converter (A); A second converter (B) configured to operate in conjunction with the first converter; and A timing circuit (X) connected to both the first converter (A) and the second converter (B), wherein timing information is shared between the first converter and the second converter.

### BACKGROUND OF THE INVENTION

1. Field of the Invention

The invention relates generally to power supplies. The invention relates more specifically to a power factor correction (PFC) circuit and technique.

First, the first object with the invention is to provide a efficient solution to the design of an interleaved electronic power factor (PFC) circuit. Secondly, the invention presents an electronic solution for controlling and enhancing the dynamic performance of transferred power in a resonant or quasi-resonant power converter.

2. Description of Related Art

A PFC circuit is utilized to condition an input power signal and provide a more desirable shaped (e.g. less distorted) input power signal by reducing current peaks on the input conductors. Universal line input refers to the ability to operate on more that one and preferably many of the different power line voltages available around the world.

One known electrical operation technique for PFC converters is discontinuous-current-mode (DCM) operation. Another technique is referred to as continuous-current-mode (CCM) operation. Critical mode operation is a technique (with respect to the PFC inductors) where the converter is operating with a triangular input current in the region between discontinuous and continuous mode. The benefit of the critical mode technique is that zero-current switching of the PFC-transistor is obtained with high efficiency and reliability. Zero current switching is obtained because the PFC-transistor does not turn-on until the current in the PFC-inductor and the PFC-diode is zero, thereby preventing the flow of recovery current. Several manufacturers of integrated circuits have commercially available control chips targeted for implementing DCM and/or critical mode operation for PFC circuits.

One example of an interleaved PFC circuit is described in the technical paper entitled “Evaluation of Input Current in the Critical Mode Boost PFC Converter for Distributed Power Systems”, by J. Zhang, J. Shao, P. Xu, F. Lee and M. Jovanovic, Center for Power Electronics Systems, pp. 27-34, 2000 CPES Power Electronic Seminar Proceedings, Sep. 17-19, 2000.

An electronic power conversion system is described in U.S. Pat. No. 5,892,352, entitled “Synchronization of the Switching Action of Hysteresis Current Controlled Parallel Connected Power Electronics Systems”.

Another example of an interleaved PFC circuit is described in U.S. Pat. No. 6,091,233, entitled “Interleaved Zero Current Switching in a Power factor Correction Boost Converter”.

A typical interleaved PFC circuit configuration is shown in FIG. 1. An input signal I is provided to a master circuit A and a slave circuit B. Operation of the master circuit A is not dependent on operation of slave circuit B. Operation of the slave circuit B is at least partially dependent on the operation of the master circuit A. For example, as illustrated, a delay circuit D is connected between the master circuit A and the slave circuit B, with the master circuit A providing a signal to the delay circuit D which in turn provides a signal to the slave circuit B. Outputs from the two circuits A and B are combined to provide a conditioned output signal O. An error signal E is fed back to the converters A and B to adjust the operation circuit.

As illustrated, the timing control of the PFC circuit is uni-directional from the master circuit A to the slave circuit B. For example, in operation the master circuit A measures the PFC-voltage or current and tries to maintain its output at a constant level. The delay circuit D includes a phase shifter which is synchronized to the gate signal of the master circuit A, and provides a 180° delay to a stop signal going to the slave circuit B. If the operation of the two circuits A and B is 180° out of phase with respect to each other the overall ripple is reduced on the input and the output because when the circuits switch the ripple does not sum up.

In general a PFC is utilized to reduce high current peaks in the input line and provide an input power signal to downstream electronics having a shape which is closer to a sinusoid. Most PFC circuits work by sensing the current in an inductor. When the current is determined to be zero, one side of an interleaved PFC circuit is triggered by closing a switch to apply power through the PFC inductor to charge up the PFC capacitor. In general the input signal to a PFC stage is sinusoidal and the output of the PFC stage is a well regulated DC signal (with some ripple). The DC output can be passed to any desirable subsequent power supply stage (e.g. a buck or a boost). The operation of each of the two sides of the interleaved PFC stage operates affects the amount of ripple, the efficiency, and the reliability. The effectiveness of the switching operation primarily determines the efficiency and reliability. For example a voltage superimposed on the switch before the switch is closed may cause a current spike which lead to reliability problems.

For interleaved PFC stages, particularly in order to maintain the benefit of universal line input, the switching of the two sides is ideally 180° out of phase with respect to each other. The two sides are frequency modulated with the particular switching frequency adjusted in accordance with the level of the mains signal. Generally, the two sides operate with longer pulses near peaks of the input signal and shorter pulses near zero crossings of the input signals.

One problem with many conventional PFC circuits using DCM techniques is that at higher power levels (e.g. 300 W-3 kW) the triangular input current requires a large and expensive mains filter. A particular problem with circuits topologies similar to that shown in FIG. 1 is providing a delay circuit which provides accurate phase shift over all the circuit conditions required. A further problem is that variations in component tolerances, particularly the PFC inductors, may negatively influence the operation of the circuit.

### SUMMARY OF THE INVENTION

One object with the invention is to provide an interleaved PFC boost converter circuit that operates over a range of input voltages and frequencies.

One aspect of the present invention is achieved by sharing of timing information between two sides of an interleaved PFC boost converter. For example, a timing control circuit may provide substantially simultaneous go and stop signals to respective sides of the interleaved PFC boost converter.

The foregoing and other objects, aspects, advantages, and/or features of the invention described herein are achieved individually and in combination. The invention should not be construed as requiring two or more of such features unless expressively recited in a particular claim.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a block diagram of a conventional interleaved PFC circuit.

FIG. 2 is a block diagram of an interleaved PFC circuit in accordance with the present invention.

FIG. 3 is a more detailed block diagram of an interleaved PFC circuit in accordance with the present invention.

FIG. 4 is a schematic diagram of a first interleaved PFC circuit in accordance with the present invention.

FIG. 5 is a timing diagram of various signals for the circuit from FIG. 4.

FIG. 6 is a schematic diagram of a second PFC circuit in accordance with the present invention.

FIG. 7 is a schematic diagram of a third PFC circuit in accordance with the present invention.

FIG. 8 is a graph of a PFC voltage versus input voltage for one example of the present invention.

FIG. 9 is a graph of the PFC coefficient versus input voltage for one example of the present invention.

### DETAILED DESCRIPTION

In the following description, for purposes of explanation and not limitation, specific details are set forth such as particular structures, interfaces, techniques, etc. in order to provide a thorough understanding of the present invention. However, it will be apparent to those skilled in the art having the benefit of the present specification that the invention may be practiced in other embodiments that depart from these specific details. In certain instances, descriptions of well known devices, circuits, and methods are omitted so as not to obscure the description of the present invention with unnecessary detail.

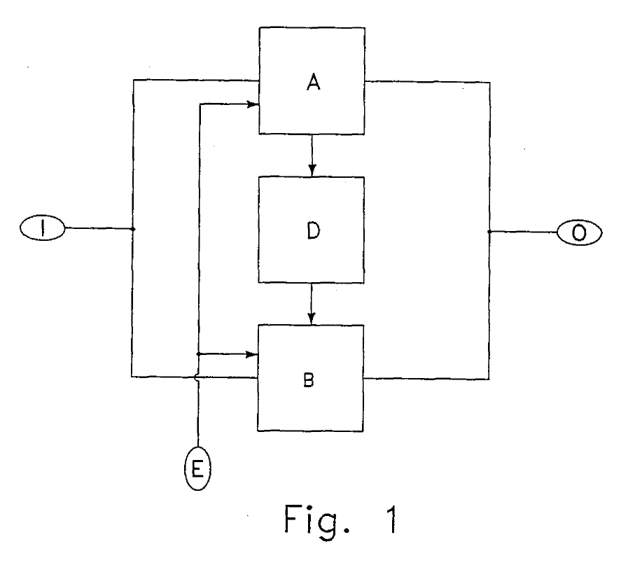

With reference to FIG. 1, practical implementations of the PFC circuit exhibit problems for universal line input applications with higher power loading levels. In order to maintain critical mode operation over a wide input operating voltage range, the phase shifter must be accurate over a wide span of frequencies which in practice is difficult to implement. In addition, manufacturing tolerances in the PFC-inductors may cause the indicator values to differ by ten percent or more, at which point zero voltage switching is not achieved. Switching which occurs when operating in continuous mode may cause spikes which results in reduced efficiency and poor reliability. In other words, when the period of operation of the master is shifted other than 180° with respect to the period of operation of the slave, the slave circuit switches at a sub-optimum time. Under these conditions, it is possible that the switching occurs before the current in the diode is zero, thereby causing spikes and stressing the components. Practical implementations may also require a protection circuit due to the possibility of temporary operation in CCM.

In contrast to the prior art, one aspect of the present invention relates to a PFC stage in which tolerance variations in the PFC inductors may lead to slightly more ripple, but the timing of the switching remains correct. For example, the present invention solves the timing problem by using a shared timing control circuit which inhibits phase shift error and provides no open loop for either portion of the interleaved circuit. Advantageously, even if the amplitude of the inductor currents are slightly different due to tolerance variations the PFC stage operates in critical mode or DCM mode. Accordingly, efficiency and reliability are maintained over a wider range of operating conditions.

At higher loads, the applicants have also observed in master/slave type PFC circuits that the slave converter exhibits a sub-frequency oscillation, because there is usually no feedback control signal of the current (sense). The circuit may, with an increased load, lock to a situation with alternating higher and lower current peaks. This is a stable but non desirable situation where the timing is correct but the current is not. One possible solution to this problem is to add current control to the slave. However, that solution adds components and complexity to the circuit. Even with current control of the slave, problems remain with respect to manufacturing tolerances and providing an accurate 180° phase shift for universal line input.

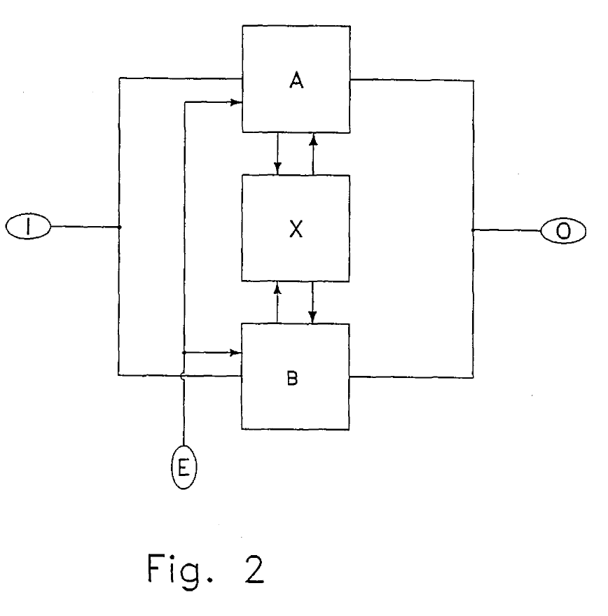

According to a present aspect of the invention, an interleaved PFC circuit utilizes a topology in which neither converter is master or slave. With reference to FIG. 2, an interleaved PFC circuit includes a first converter A and a second converter B which receive a common input signal I. A timing circuit X is shared between the two converters A and B. The first converter A provides a signal to the timing circuit X and receives a signal from the timing circuit X. Operation of the first converter A is at least partially dependent on the signal it receives from the timing circuit X. The second converter B also provides a signal to the timing circuit X and receives a signal from the timing circuit X. Operation of the second converter B is at least partially dependent on the signal it receives from the timing circuit X. Both converters A and B receive an error signal E. The output from both converters A and B is combined to provide a conditioned output signal O.

Because the timing circuit X is shared between the two converters A and B, the period of operation of both converters is the same. The PFC circuit is tolerant of manufacturing variations affecting the timing circuit X because such variations are applied equally to both converters A and B. More importantly, the phase shift is accurate under a wide range of operating conditions because the timing circuit X turns off the converter A at the same time it turns on the converter B (and vice versa). Accordingly, there can be no overlap in operation of the two converter stages.

The converters A and B are configured as two co-equal circuits with a bi-directional timing circuit X controlling the operation of both sides. The novel topology is applicable for all power levels, although it may find particularly beneficial application in the medium power range of 300 W-3 kW. The novel topology is applicable to various regulation control modes including but not limited to voltage, current, and hysteresis.

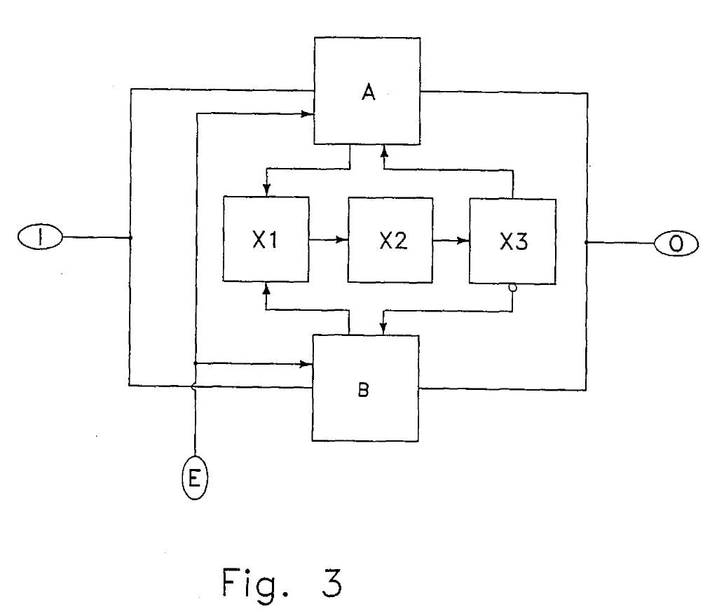

With reference to FIG. 3, a novel timing circuit includes a memory circuit X1, an integrator X2, and a sign detect circuit X3. The memory circuit X1 receives respective signals from both converters A and B and provides an output signal to the integrator X2. The integrator X2 provides a signal to the sign detect circuit X3 which provides respective signals to both converters A and B. The other circuit connections are as described above with respect to FIG. 2.

Operation of the circuits is generally as follows. The two converters A and B work in a desired control mode of, for example, current control or time control. The memory circuit X1 holds a value corresponding to which converter (A or B) operated during the preceding period. The integrator X2 is configured with a suitable time range corresponding to the working frequency of the converter and produces either an increasing or decreasing output in accordance with the signal from the memory circuit X1. The sign detect circuit X3 senses the polarity of the output of the integrator X2 and provides respective signals (e.g. complementary signals) to the converters A and B indicating which of the two converters should operate.

The memory circuit X1 has an initial value. For example the value is a logical 0 or a logical 1 corresponding to an appropriate output voltage (e.g. zero volts or five volts). The value of the memory circuit X1 is provided to the integrator X2. The integrator generates a ramp signal which has either a positive slope or a negative slope in accordance with the value of the memory circuit X1. The ramp signal from the integrator X2 is provided to sign detect circuit X3. The sign detect circuit X3 compares the ramp signal to a reference value. When the ramp signal crosses the reference value the circuit X3 substantially simultaneously provides a “go” signal to one converter and a “stop” signal to the other converter in accordance with the direction of the ramp signal. The converter which received the “go” signal provides a signal to the memory circuit X1 which causes the value of the memory circuit X1 to toggle.

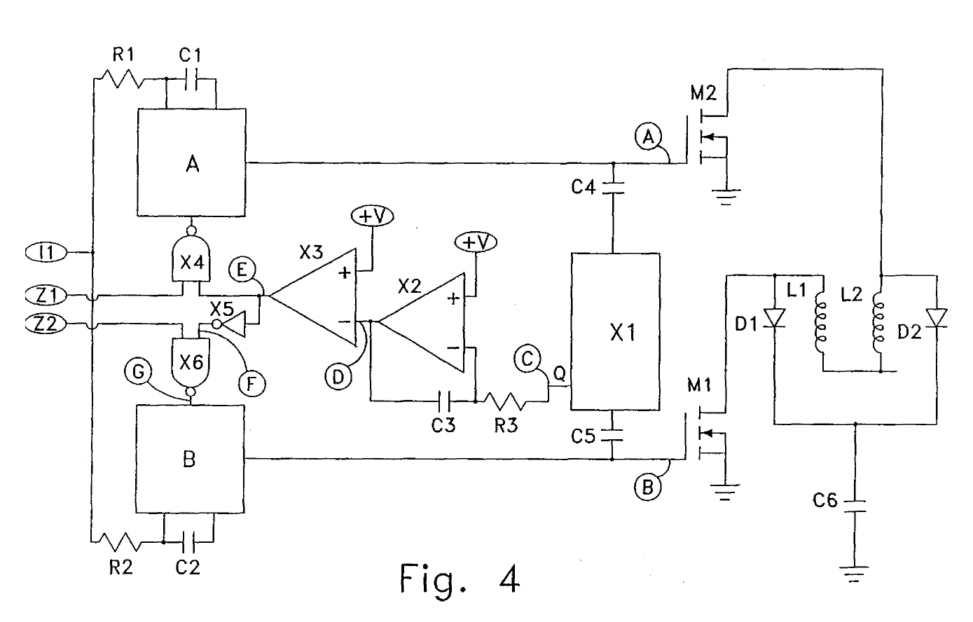

With reference to FIG. 4, a first example PFC circuit includes a first control chip A1 and a second control chip B2 which receive the input signal I1 (e.g. the current sense or output voltage) through respective conditioning components (e.g. resistor R1/capacitor C1 and resistor R2/capacitor C2) to a monostable driver. The first control chip A1 provides a gate signal A to a gate of a transistor M1. The source of the transistor M1 is grounded and the drain of the transistor M1 is connected to one terminal of the PFC inductor L1 and also to a cathode of a PFC diode D1. A second control chip B2 provides a gate signal B to a gate of a transistor M2. The source of the transistor M2 is grounded and the drain of the transistor M2 is connected to one terminal of a PFC Inductor L2 and also to a cathode of a PFC diode D2. The respective other ends of the PFC inductors L1 and L2 are tied in common and provide the input voltage of the circuit. The anode ends of the PFC diodes D1 and D2 are tied in common (the output) and connected to one terminal of a PFC capacitor C6. The other terminal of the PFC capacitor C6 is grounded.

The PFC circuit further includes a timing control circuit shared between the two stages. The timing control circuit includes a toggle flip flop X1 which receives respective toggle signal from the two gate signal lines via respective capacitors C4 and C5. The output signal C of the flip flop X1 is provided to a negative input terminal of an integrator X2 (e.g. comprising a comparator) via a resistor R3. The positive terminal of the integrator is connected to a reference voltage V_{REF1} and the output of the integrator X2 is fed back to the negative input terminal of the integrator X2 via a capacitor C3. The output signal D of the integrator X2 is provided to a sign detect circuit (e.g. comprising an operational amplifier) at the negative input terminal of the circuit X3. The positive terminal of the circuit X3 is connected to a reference voltage V_{REF2}. The output signal E of the sign detect circuit is provided to the first control chip A1 and through an inverter X5 to the second control chip 82.

The PFC circuit further includes additional logical elements which determine when the two stages may operate. Specifically, the output of the sign detect circuit X3 is combined with respective zero signals from the two stages to ensure that zero current switching is obtained. The non inverted output of the circuit X3 is provided to a logical NAND circuit X4 and a zero signal Z1 from the first stage is provided to another input of the NAND circuit X4. The output of the NAND circuit X4 is provided to the control chip A1. The inverted output signal F of the circuit X5 is provided to a logical NAND circuit X6 and a zero signal Z2 from the second stage is provided to another input of the NAND circuit X6. The output signal G of the NAND circuit X6 is provided to the control chip B2.

The general operation of the PFC circuit is as follows. The two control chips A1 and B2 work with a controlled current limit or controlled ON-time corresponding to a feedback signal sensing the PFC-voltage output. The controllers have zero signal control inputs sensing when the current through the PFC-diodes, for each period, has stopped entirely. The memory circuit is the flip-flop X1 that remembers which half of the circuit that produced the last positive going output gate-pulse signal. The integrator X2 is attached to the flip-flop and generates a suitable time range for the working frequency of the converter. The sign detect circuit X3 senses the polarity of the output of the integrator X2, and has two complementary outputs (one via the inverter X5). For example, reference voltage for the sign detect circuit is 2.5 V if the memory value is either 0 V or 5 V. The logic circuits (X4 and X6) logically combine the zero current signals (Z1 and Z2) of each converter with respective outputs from the sign detector X3 before permitting the respective PFC-control circuit A1 or B2 to start a new period.

The integrator X2 output generates a delayed “clear-to-go” gate signal to the respective PFC-controller after the flip-flop X1 has toggled. A new period can start for a converter side when the “clear to go” is in the appropriate state for that side and the zero signal is indicating zero current. The delay function will automatically force the other side to wait if the first side is delayed due to component difference, passive or active. The present invention facilitates 180° phase shift for a wide range of frequencies as this phase information is delayed and passed in both directions the same way.

Any frequency dependent extra delay will be the same both ways, thus symmetry is maintained. This is important as the working frequency varies over a large span, from a low frequency (e.g. 40-100 kHz in practice with present technology) when the mains voltage is momentarily high until the point where the mains voltage is momentarily close to zero where the frequency can go very high (for example, >400 kHz). The circuit will, if PFC-controllers A1 and B2 are configured with controlled ON-time, give a final dead-time on one of the channels that depends only on possible tolerance variations in the ON-time between the two circuits. The converter side with the longest ON-time will always have minimum dead time. Variations in the PFC-inductor values will not adversely affect the function of the circuit.

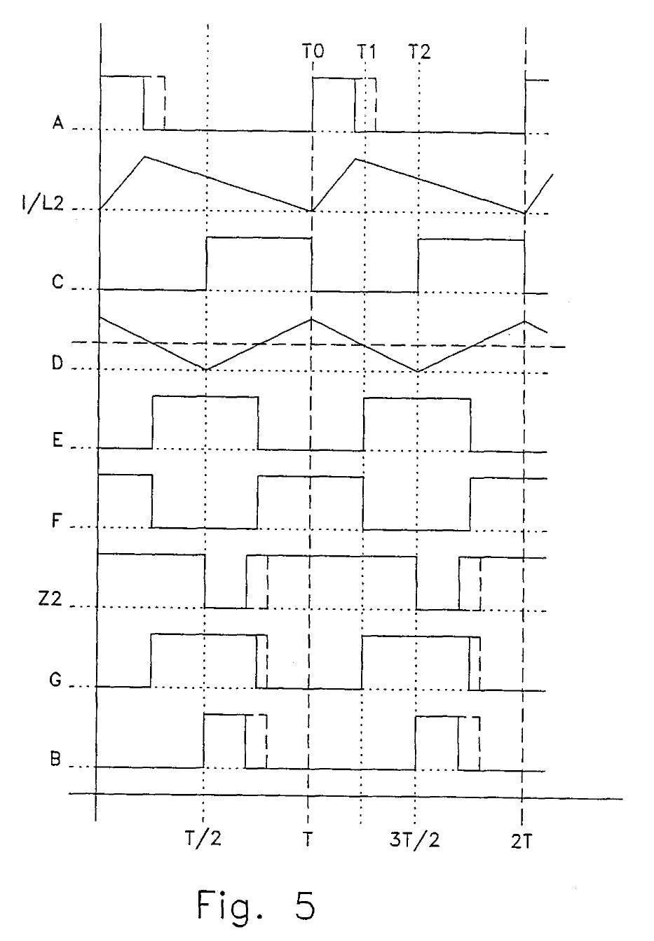

With reference to FIG. 5 represent signal waveforms are illustrated for signals A-G, I/L2 and Z2. The signal A is the gate signal to the transistor M2. Signal A goes high at time T0 (Based on the output signal C of the flip-flop X1). The duration of the pulse for the signal A depends on the mains voltage and the power level. However, the duration of the pulse is not critical to the timing of the circuit because the flip-flop X1 is edge triggered. The waveform I/L2 is representative of current flowing through the inductor L2. The current in the inductor L2 increases when the transistor M2 is conducting.

The signal C is representative of the actual status of the output of the flip-flop X1. The output signal C toggles with the rising edge of the signal A and toggles again with the rising edge of the signal B. The output signal D of the integrator X2 starts to go negative at the time T0 as a result of the flip-flop changing. The output signal E of the comparator X3 goes high when the integrator output signal D goes under the reference level at time T1. The signal E and its complement F are substantially simultaneously provided to the two control chips A1 and B1, via additional control logic circuits X4 and X6.

In this cycle, at time T1, the comparator output E goes from low to high, thus providing a “clear to go” signal on the inverted output signal F for control circuit B1. The control circuit B1 then awaits the arrival of a low signal Z2. The signal Z2 goes low when the inductor L1 has fully released its energy to capacitor C6 via diode D1. The signal Z2 returns to zero at time T1 thus making the signal G go low and enabling the control circuit B1.

The signal B goes high at time T2 thus causing the transistor M1 to conduct. The operation of the circuit repeats in a symmetrical manner from this point in time with the B side of the circuit instead of the A side of the circuit. The current through L2 starts to increase, the flip-flop toggles back to the state before time T0, and the integrator starts to increase its output voltage. When the integrator crosses the reference voltage, one side of X4 in enabled and the control circuit A1 awaits the signal Z1 becoming low.

From the foregoing it is apparent that both control circuits A1 and B1 are gated by the integrator X2 output and the zero current signals Z1 and Z2. Both signals must be in the appropriate state before switching control. If one side is late in starting due to a late arriving zero signal, then the other side will automatically be delayed a time corresponding to a 180° phase shift due to the symmetry of the integrator.

In the timing diagram as illustrated, the circuit provides headroom between the transition of the signal E and the corresponding zero signal Z1 and Z2. In practical circuits, however, component tolerances may alter the precise symmetry of operation with respect to the zero signals, and one side may have little or no headroom as compared to the other side. An advantage of the circuits is that, even with component tolerance variations, symmetry in time is maintained because the zero signal is utilized together with the integrator X2 output to activate the next control side of the converter.

When one half of the circuit stops due to PFC-voltage reaching an upper limit then the other side will stop automatically. In other words, one side cannot operate on its own.

It is understood that the current sharing may become unbalanced with the effect that the total ripple will increase. However, the amount of ripple is well within acceptable limits, particularly for the advantages provided relating to improved efficiency and reliability.

Practical circuits may be configured for operation with mains signals from DC to 80 Hz. DC operation makes the interleaved PFC boost converter of the present invention suitable for backup battery power.

In conventional PFC stages, the PFC capacitor may be life-limiting. The present invention reduces electrical stress on the PFC capacitor, thereby reducing requirements.

A preferred PFC circuit in accordance with the present invention incorporates the follow features:

1) Interleaved operation with two PFC-inductors and two PFC control chips for higher power operating levels;

2) On-time control of both halves of the PFC circuit;

3) A shared timing circuit;

4) Critical mode operation of the PFC control chips for reliability;

5) Critical mode operation for both PFC inductors; and

6) Tolerance of a slight amount of DCM operation of one of the circuits.

Utilizing on-time control of the PFC stages reduces or eliminates the effect that manufacturing variations in the PFC inductor values have on the timing and phase-shift between the two channels.

The shared timing circuit provides 180° phase shift between the two converter's timing for reduced ripple. As noted above, the timing circuit is shared to provide symmetry of the function. The phase information between the two converters is bi-directional in order to get 180° phase shift under a wide range of conditions while inhibiting any phase disturbances.

One stage is always operated in critical mode. The other stage generally operates in the critical mode, but may operate in DCM. DCM is as efficient as CCM and more reliable as compared to CCM.

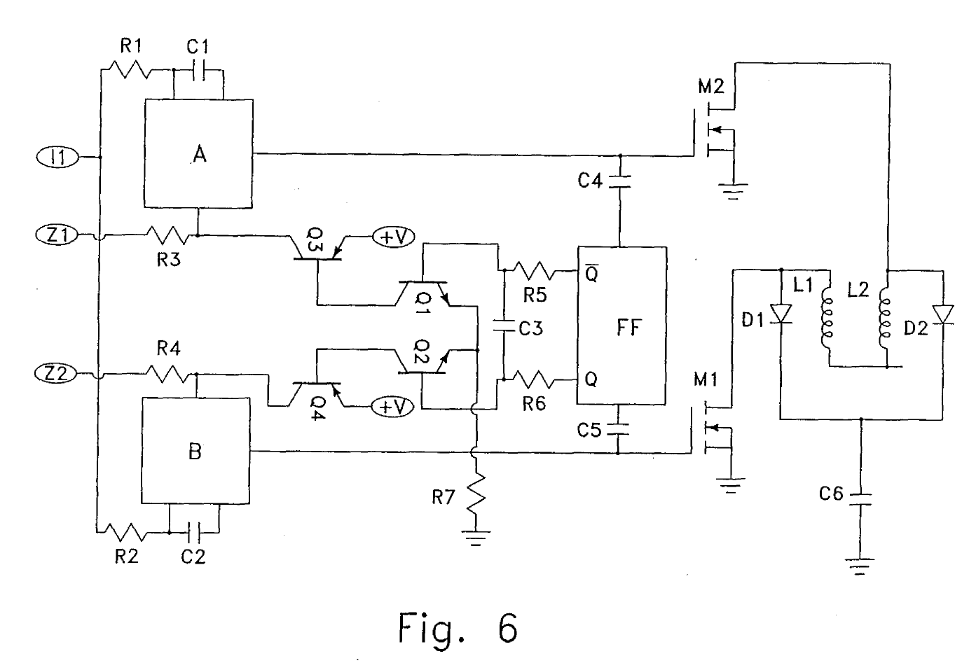

There are many practical ways to implement the operating principles mentioned above. The circuit described in FIG. 6 is one example which is simple and does not require a conventional analog amplifier and comparator. It is built with a flip-flop and four high-speed transistors, Q1-Q4, and one integrator (resistors R5, R6 and capacitor C3). The NAND-ing function is implemented by holding respective zero inputs of the PFC-control chips high via Q3 or Q4, thus stopping a new cycle from starting, until the integrator output allows the respective control circuit to re-trigger. (The zero signal is low when the PFC-inductor current is zero)

The two PFC-controllers operating in critical-mode can basically work according to two dominating techniques. Namely, controlling the on-time or controlling the current.

Controlling the on-time is an example of a technique used by the TI/Unitrode chip UC3852. The chip uses a constant ON-time set by an error amplifier with respect to the mains frequency. The chip provides a sine-shaped mains current with a high power factor as I=V·dt/L. The chip does not control the peak current normally, except for setting an upper limit. However the circuit senses the current at a low minimum level to determine when to turn on the PFC-transistor each cycle.

These integrated circuit's exhibit excellent part to part-tolerance. Therefore the RC-link needed by the chip is predominating source of error.

A SG-Thomson integrated circuit having part number L6561 and L6562 uses an example of a technique which involves controlling the current. In this chip, a multiplier having the input from a divider sensing the input voltage and the error amplifier controls the envelope of the peak current. The result will in the end be more or less the same as in the case outlined above, namely the ON-time will be constant over the mains period.

An advantage of this circuit is the way the circuit determines when to start the next pulse. A zero detector input senses when the voltage reverses over the PFC-inductor. This can only happen after the current through the PFC-inductor. This can only happen after the current through the PFC-diode has stopped entirely. Accordingly, the circuit prevents any recovery current at all.

The two methods mentioned above treats variations in component values in a different way. Variations in controlling the ON-time will give a variation in peak current but the period time will stay constant even if the PFC-inductor changes. Controlling the peak current on the other hand is not possible if the period time has to be the same with different inductor values. At least not if the current is the same for both PFC-circuits.

It was, as a remainder, for this reason already above concluded that only controlled ON-time would work well. The only really important thing that matters in a topology with controlled ON-time is the difference in the pulse-width of the two converters.

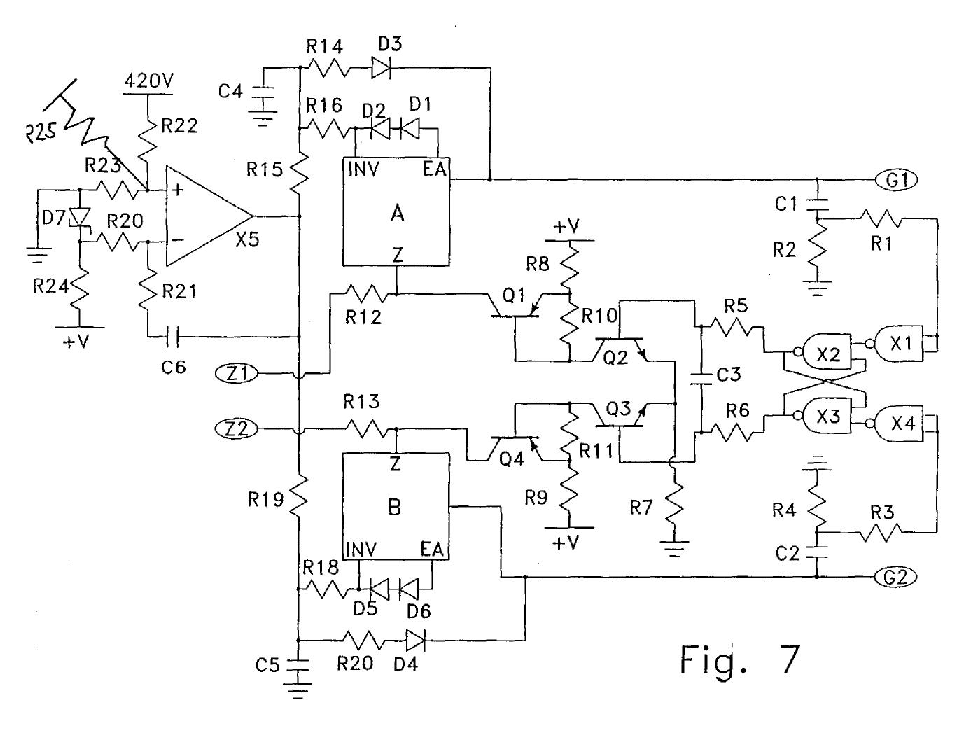

With reference to FIG. 7, another aspect of the present invention is based on the L6561 and L6562 for following reasons. The temperature range and input tolerance of this circuit is very good. The way the controller is re-triggered has attributes which are suitable for implementation of the present invention. The present design incorporates aspects from both circuits above. The present L6561 circuit works primarily with a multiplier for current control thus giving almost constant ON-time but otherwise uses its normal basic functions. An extra error amplifier circuit is utilized instead of the internal error amplifier. The internal error amplifier is utilized as a comparator.

Both controllers (A and B) have 6-10:s with following functions:

1—Not shown here is the multiplier input to the both controllers A and B with a resistive divider from the rectified mains.

2—The inverter input is for the internal error amplifier. This amplifier has an internal reference of 2.5 V at the non-inverting input.

3 (EA)—The error amplifier output is limited to a desired voltage (e.g. 3-4V) by two diodes.

4 (Z)—The zero current detection input. Will activate the circuit whenever a low is sensed after a pulse has been generated.

5(I)—The current sense input. This input is used, but not the nominal way, as it is the length of the pulse that terminates the current.

6—Finally, there is a gate output driving the external FET:s. This output synchronizes the timing capacitors C4 and C5 when the signal respectively goes low.

The on-time control is made possible by having the PFC-controller output discharging a capacitor (C4 and C5) when the PFC-transistor is off. The same capacitors will start to charge at a rate set by the error amplifier X5 output level when a pulse has once started. This charging will continue until the voltage level on the respective capacitor has reached a level of 2.5 V where, in this case, the built in error amplifier of L6561 acts as a comparator. The EA output of L6561 starts to go low, and as this output level controls the current, the pulse will be terminated when the set value corresponds to the actual current.

Both circuits will stop entirely when the PFC-voltage is high enough that the dividers formed by R14-R15 and R17-R18 hold respectively timing capacitor permanently charged to 2.5 V. There might be a slight difference of this level between the two circuits due to normal component tolerances. This does not matter, as the integrator with the following AND-gates will not permit one circuit to operate on its own. This is the process that will take over when the mains voltage reaches a peak operating voltage. Both circuits will stop whenever the peak mains voltage is higher than the PFC-capacitor.

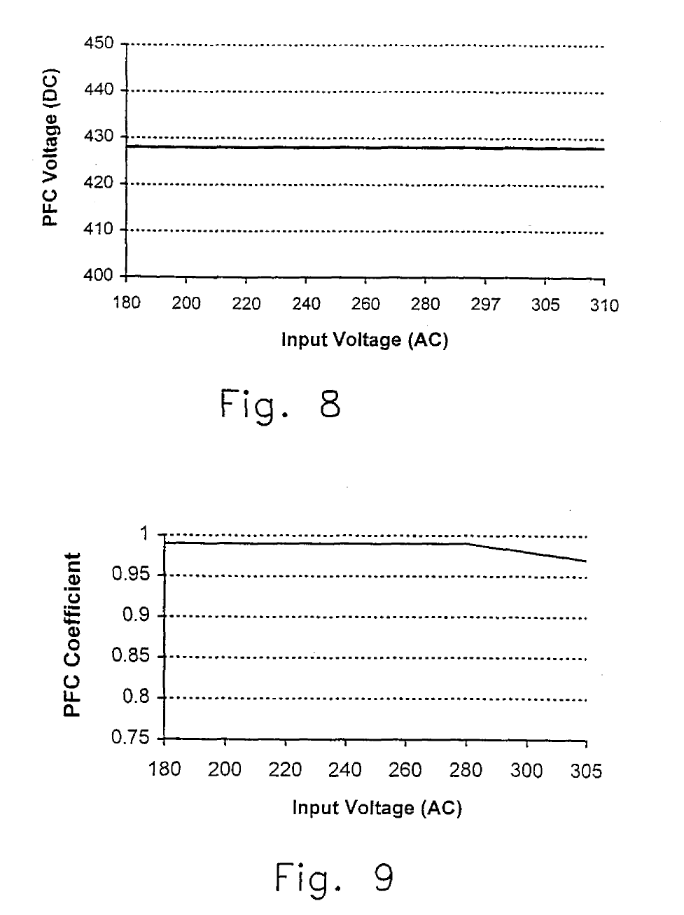

With reference to FIGS. 8 and 9, representative performance graphs of the interleaved PFC circuit of the present invention show the PFC voltage and the PFC coefficient over a range of input voltages. Based on actual hardware tests, examples of the PFC circuit of the present invention generate excellent PFC voltage regulation over a wide input voltage range (see FIG. 8). The PFC coefficient is maintained at greater than or equal to 0.99 for most of the input range, trailing of slightly at the upper ranges (see FIG. 9).

Moreover, the present interleaved PFC-circuit design can be further improved by including an input for controlling the outgoing PFC-voltage. This feature can be of importance for example when there is a need of controlling the transferred power where the secondary converter normally used after the PFC-stage in a power supply design (not described herein) is a resonant or a quasi resonant converter and the transferred power is related to the operation frequency and voltage and voltage of this secondary converter.

The overall dynamic of the power control in electronically power supply for a magnetron for instance, can thus be enhanced by controlling both the frequency of the secondary converter (by an external controlling device and) at the same time as the output voltage of the PFC-stage is controlled by said controlling device.

With reference to FIG. 7 the above described feature has been archived by adding REF and resistor R25.

While the invention has been described in connection with what is presently considered to be preferred embodiments, it is to be understood that the invention is not limited to the disclosed embodiments, but on the contrary, is intended to cover various modifications and equivalent arrangements included within the spirit and scope of the inventions.

1. An interleaved power factor correction (PFC) boost converter, comprising:
A first converter (A);
A second converter (B) configured to operate in conjunction with the first converter (A);
a timing circuit (X) connected to both the first converter (A) and the second converter (B), wherein timing information is shared between the first converter and the second converter said converters receiving a common input signal (I), and wherein
the first and second converter (A and B) provides and receives signals in connection to the timing circuit (X) where the operation of the first and second converter (A and B), respectively, at least partially is dependent on the signals received from the said timing circuit (X), and
the first and second converter (A and B) are arranged to receive an error signal (E) and providing a conditioned output signal (0) back to the converters A and B to adjust the circuit operation, and
the first converter (A) and second converter (B) are configured as two co-equal circuits having equal priority regarding circuit operation, and wherein the boost converter further comprising
a memory circuit (X1), an integrator (X2), and a sign detect circuit (X3), the memory circuit (X1) receiving respective signals from both converters (A and B) and providing an output signal to the integrator (X2) which in turn provides a signal to the sign detect circuit (X3) providing respective signals to both said converters, wherein
the memory circuit (X1) holds a value corresponding to which of the converters (A or B) operated during the preceding period, and
the value of the memory circuit (X1) is provided to the integrator (X2) for generating a ramp signal having either a positive slope or a negative slope in accordance with the value of the memory circuit (X1), and
the sign detect circuit (X3) senses the polarity of the output of the integrator (X2) and provides respective signals to the converters (A and B) indicating which of the two converters that should operate, characterized in that the boost converter comprises a circuit for controlling the outgoing PFC-voltage.

2. A circuit as claimed in claim 1, wherein the outgoing PFC-voltage circuit comprises a resistor (R25) having one connection to the positive terminal of an amplifier (X5) forming part of the boost converter circuits and the other terminal to ground.
